(19) United States
(12) Patent Application Publication
(10) Pub. No.: US 2003/0032198 A1
(43) Pub. Date: Feb. 13, 2003

(54) High throughput dispensing of fluids

(75) Inventors: Claus G. Lugmair, San Jose, CA (US); Daniel M. Pinkas, Alameda, CA (US)

Correspondence Address: Eric M. Dobrusin, Dobrusin & Thennisch PC, Suite 311, 401 South Old Woodward Avenue, Birmingham, MI, 48009, US

(73) Assignee: Symyx Technologies, Inc.

(21) Appl. No.: 09/928,761

(22) Filed: Aug. 13, 2001

(51) Int. Cl. G01N 1/10

(52) U.S. Cl. 436/180; 422/100

(57) ABSTRACT

This invention provides an apparatus and method for dispensing fluidic materials involving the employment of a hydrophilic capillary dimensioned for drawing a liquid therein in a volume less than about 10 microliters; a hydrophobic medium sealingly adjoining said capillary and defining an interface therewith for resisting flow of the liquid into the capillary beyond the interface; and a source of a pressure pulse for ejecting fluids drawn into the capillary.

### FIELD OF THE INVENTION

The present invention generally relates to methods for high throughput dispensing of fluidic materials, and more particularly to the high throughput synthesis of libraries of materials by the rapid delivery of liquid reagents to a substrate.

### BACKGROUND OF THE INVENTION

The discovery of new materials with novel chemical and physical properties often leads to the development of new and useful technologies. Over forty years ago, for example, the preparation of single crystal semiconductors transformed the electronics industry. Currently, there is a tremendous amount of activity being carried out in the areas of new materials. Unfortunately, even though the chemistry of extended solids has been extensively explored, few general principles have emerged that allow one to predict with certainty composition, structure and reaction pathways for the synthesis of such solid state compounds, compositions or structures. Moreover, it is difficult to predict a priori the physical properties or the microstructure that a particular material will possess.

Clearly, the preparation of new materials with novel chemical and physical properties is at best happenstance with our current level of understanding. Consequently, the discovery of new materials depends largely on the ability to synthesize and analyze new materials, compounds, compositions or structures. Given approximately 100 elements in the periodic table that can be used to make such compositions consisting of three, four, five, six or more elements, the universe of possible new compounds remains largely unexplored. As such, there exists a need in the art for a more efficient, economical and systematic approach for the synthesis of potential new compounds, compositions or structures (e.g., materials) and for the screening of such new materials, or even of existing materials, for structural information potentially bearing upon the useful properties of the materials.

Schultz et al., in U.S. Pat. No. 5,985,356 entitled “Combinatorial Synthesis of Novel Materials” disclose methods for preparing and screening arrays of materials for combinatorial material science applications such as catalysis, and is incorporated herein by reference.

The art continues to grapple with the development of improved or alternative fluid delivery devices for the rapid dispensing of fluids as part of a combinatorial research program. See, e.g., U.S. Pat. Nos. 6,001,309; 6,110,426; 6,149,870; 6,132,685; incorporated by reference. Other efforts to develop alternative dispensing techniques for small quantities of fluids are illustrated in U.S. Pat. Nos. 6,158,269; 6,143,252; 6,096,271; 6,090,251; 6,024,925; 6,013,528; 5,957,167; 5,948,359; 5,915,284; 5,882,597; 5,865,224; 5,807,522; 5,798,035; 5,578,270; 5,544,535; 5,525,302; 5,306,510; 5,226,462; 5,055,263; 4,554,839; and International Publication WO 00/21666 A1 all of which are herein incorporated by reference.

This invention provides a new approach to the rapid delivery of small quantities of fluids. The invention can be used to make known materials or new materials. In addition, this invention provides a general route for the synthesis of arrays of transition metal and other oxides for screening for heterogeneous catalytic properties.

### SUMMARY OF THE INVENTION

This invention provides an apparatus and method for dispensing fluidic materials involving the employment of a hydrophilic interior wall of a conduit dimensioned for drawing a liquid by capillary action therein in a volume less than about 10 microliters; a hydrophobic medium adjoining said hydrophilic wall and defining an interface therewith for resisting flow of the liquid into the capillary beyond the interface; and a source of a pressure for ejecting fluids drawn into the capillary.

In the context of new materials discovery research, the present invention will provide an efficient and rapid approach for the preparation of large libraries of materials for subsequent screening. The present invention permits for the use of liquid chemistry techniques for the rapid and efficient synthesis of small quantities of sample materials, including those prepared using automated instruments. The present invention thus readily lends itself for use in combination with high throughput screens to identify potentially significant new materials or to characterize existing materials.

### DESCRIPTION OF DRAWINGS

FIG. 1a is perspective view of one embodiment of a capillary dispenser array in accordance with the present invention.

FIG. 1b is a perspective view of a row of dispensers for assembly into the array of FIG. 1a.

FIG. 1c is a sectional view of a dispenser employed in the dispenser array of FIG. 1a.

FIG. 1d is a perspective of a system employing the dispenser array of FIG. 1a.

FIG. 2a is an exploded perspective of a device for use in assembling a capillary dispenser array of the type shown in FIGS. 1a-1d, and particularly FIG. 1b.

FIG. 2b is a perspective of the device of FIG. 2a.

FIG. 3a is plan view of one layer of another embodiment of a capillary dispenser in accordance with the present invention.

FIG. 3b is an elevation view to show two layers of the type shown in FIG. 3a in stacked adjoining relation.

FIG. 4 is a schematic of an example of a pressure source for fluid injection.

### DETAILED DESCRIPTION OF PREFERRED EMBODIMENT

The following terms are intended to have the following general meanings as they are used herein:

Region: A region is a localized area on a substrate intended to be used for formation of a selected material and is otherwise referred to herein in the alternative as a “known” region, “reaction” region, “selected” region, “individual” region, or simply a “region.” The region may have any convenient shape, e.g., circular, rectangular, elliptical, wedge-shaped, etc. A discrete region and, therefore in some embodiments, the area upon which each distinct material is synthesized is smaller than about 25 cm², preferably less than 10 cm², more preferably less than 5 cm², even more preferably less than 1 cm², still more preferably less than 1 mm², and even more preferably less than 0.5 mm². In most preferred embodiments, the regions have an area less than about 10,000 μm², preferably less than 1,000 μm², more preferably less than 100 μm², and even more preferably less than 10 μm². In general, the regions are spatially addressable. In certain embodiments, the regions are discrete. For instance, the regions are separated from each other so that a material in a first region cannot interdiffuse with a material in a second region and thus the regions have a minimum size. In other embodiments, the regions are continuous.

Substrate: In many embodiments, at least one surface of the substrate will be substantially flat (and the substrate will contain no discrete regions), although in some embodiments it may be desirable to physically separate regions for different materials with, for example, dimples, wells, raised regions, etched trenches, or the like. In some embodiments, the substrate itself contains wells, raised regions, etched trenches, etc., which form all or part of the regions (for example a microtiter plate). The regions may be coated (e.g., silanized) or not. By way of example, the substrate may be a wafer, e.g., an elongated thin member, or it may be a member having a larger thickness (such as a metal plate with apertures defined therein or a tray containing an array of reaction sites or micro-reactors). Porosity, surface texture or topology of the substrate may be varied as desired to provide a suitable amount of surface area and desired porosity for separation of solids from fluids.

The preferred method and system for dispensing or delivery of the material to a substrate in accordance with the present invention provides a capillary dispenser array for non-contact capillary dispensing of a fluid onto a substrate. The dispenser relies on the capillary principles of fluids for both maintaining the fluid within the system and dispensing the fluid through a dispenser formed of hydrophobic and hydrophilic portions. The system, as described below, may also be microfabricated for dispensing fluid through microfluidic channels defined in substrates as part of a microfluidic analytical system.

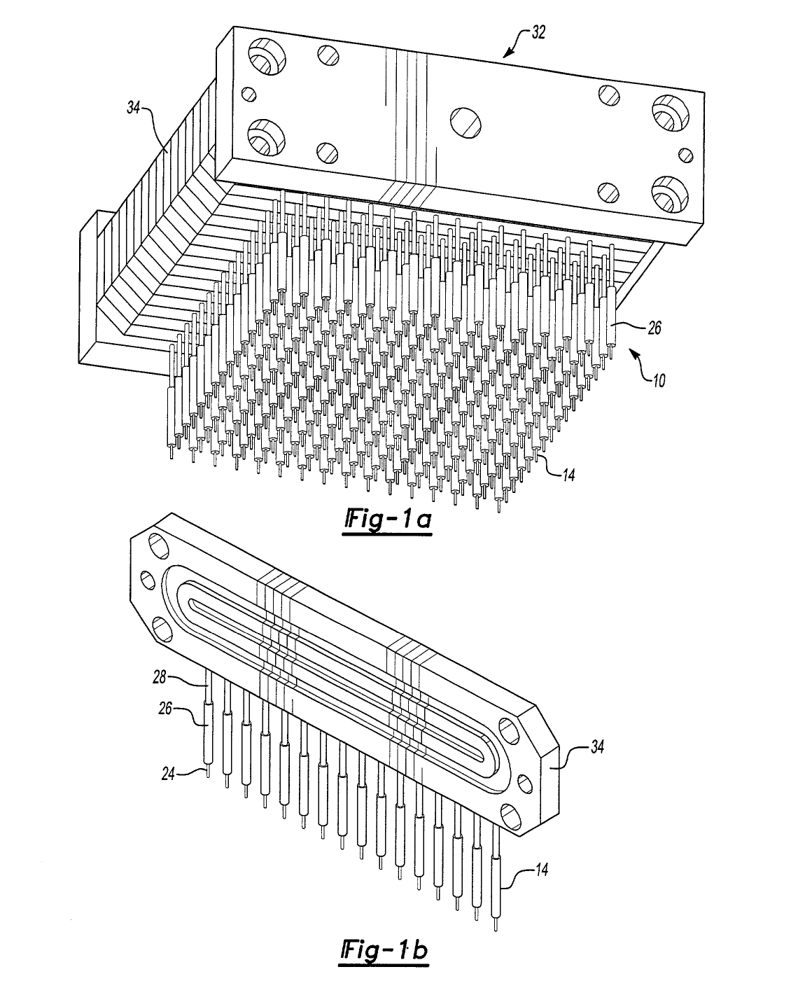

One capillary dispenser array 10 of the present invention for dispensing onto a substrate 12 is shown in FIGS. 1a-d and is preferably formed by an array of dispensers 14. By way of example, the embodiment illustrated has 256 dispensers arranged in a 16×16 array for dispensing quantities on the order of about 10 to about 500 nL, and more preferably about 200 nL of fluid onto the substrate 12. It will be appreciated that any suitable number of dispensers may be employed. For example, a single dispenser may be employed (e.g., for rapid serial dispensing). More preferably, at least 2×N dispensers are used, where N is an integer 1 or greater. In another embodiment, at least 2^{M} dispensers are used, where M is an integer 1 or greater.

Referring more particularly to FIG. 1c, each dispenser 14 is characterized as having at least a first portion 16 terminating at a tip 18 (which may be suitably cut and polished), and a second portion 20 upstream of said first portion. The first portion 16 and the second portion 20 are preferably connected via an intermediate structure in which there is defined an interface 22, which may be at an end of the first portion or an intermediate location along the first portion. The interface 22 is such that the surface tension that results at such interface is generally equal to or greater than the opposing tension resulting from the capillary flow of fluids in the dispenser 14. In this manner, the fluids are allowed to be transported by capillary action through the first portion, and upon reaching the second portion, will generally be prevented from entering the second portion absent any force other than derived from the capillary flow. This can be accomplished in any of a number of ways. For example, it may be possible to coat the inside of the dispenser to result in a substantial change of hydrophobicity of the inner wall of the dispenser at or near the interface for inducing opposition to the capillary action. The use of a coating, surface treatment or otherwise providing different adjoining materials may produce a like effect. Structural modifications are also possible, such as the incorporation of a flange or other projection to achieve a diameter change, or a wall at or near the interface.

In one particularly preferred embodiment, the dispenser includes a capillary 24 defining the first portion 16, a sheath 26 as at least part of the second portion 20 and optionally an upstream conduit 28, which may serve as a third portion 30. The sheath 26 preferably is a generally hydrophobic material such as PTFE (e.g., TEFLON®), or the like. In a preferred embodiment, at least a portion of the interior of the capillary 24 is generally hydrophilic. The interface 22 between them thus introduces a substantial surface tension gradient that functions to help keep fluids from leaving the capillary 24 into the region of the sheath 26, or to help return those quantities of fluids that enter the sheath. The inner diameter of the sheath 26 is large enough that the sheath may be placed over the capillary, but small enough that a substantially fluid tight seal is created between the sheath and the capillary. It is also possible that the sheath is configured to be inserted into the capillary passageway.

In one embodiment, the sheath 26 may be connected directly to a manifold 32. For instance, as shown in FIG. 1, the sheath 26 may be connected to the upstream conduit 28 associated with (either integrally formed or attached by weld, adhesive, threading or the like) a holder portion 34 of the manifold 32. The holder portion 34 may comprise one or a plurality of dispensers, and may be a row, column or other collection of dispensers. A plurality of holder portions may be assembled together or integrally formed to form the array 10, and may also define the manifold 32.

Instead of the upstream conduit, it is also possible that the sheath 26 be inserted as a male connector into a corresponding female aperture of the manifold 32. In another embodiment, an intermediate structure is placed between the manifold 32 and the sheath 26. In yet another embodiment, the sheath is integrally formed with the manifold.

In a particularly preferred embodiment, each individual dispenser 14 includes a polyimide coated fused silica capillary (though it may be steel or other suitable material for micromachining) that is connected to a stainless steel tubular upstream conduit 28 with a sheath 26 made of heat shrinkable PTFE (Teflon®) tubing. Control over the amount of fluid dispensed by the capillaries in one embodiment, can be controlled by choosing dimensions (e.g. the diameter and length) of the respective capillaries. The inner diameter of the capillary ranges from about 25 μm to about 500 μm and more preferably is about 200 μm to about 300 μm (e.g., 250 μm). The capillary preferably is about 0.5 mm long or longer (e.g., about 4.4 mm). Desirably the dispenser is capable of dispensing in amounts on the order of about 1 nl, and more preferably about 25 to about 50 nL, but more preferably for the applications discussed herein, will dispense amounts of about 200 nL. Of course, larger scale dispensing is also possible using the present invention, e.g., about 1 to about 10 μL or higher.

The manifold 32 of the present invention is configured for receiving and holding (e.g., with the holders 34) the dispensers 14. Preferably, the manifold is disposed in fluid communication downstream from, or otherwise itself includes, a pressure (negative or positive) source, such as a gas source. Moreover, preferably the manifold is also in suitable fluid communication with the capillaries (e.g., via suitable channels defined in or by the holders 34) and is capable of delivering a substantially equal pressure to each dispenser 14 associated with the manifold. In this manner, it is assured that during dispensing, substantially equal amounts of fluids drawn into the dispensers 14 are released from the dispensers 14 upon application of pressure.

In a particularly preferred embodiment, the tips 18 of each capillary are aligned in a common plane. Further the longitudinal axes of each capillary are substantially parallel to each other. Other configurations are possible as well. For example, the tips may be aligned in a common plane and the longitudinal axes of the capillaries may be disposed at an angle relative to each other. The tips may be aligned in a common plane and the longitudinal axes of the capillaries may be disposed parallel to each other but at an angle relative to the manifold. Fewer than all of the tips may be aligned in a first common plane, with other tips aligned in a second common plane. Other variations will be apparent to the skilled artisan. Moreover, it is possible that other features may be combined with or integrated into the present device. For example, if desired, a heating element or other suitable heat exchanger may be provided in the device for warming or cooling the capillaries.

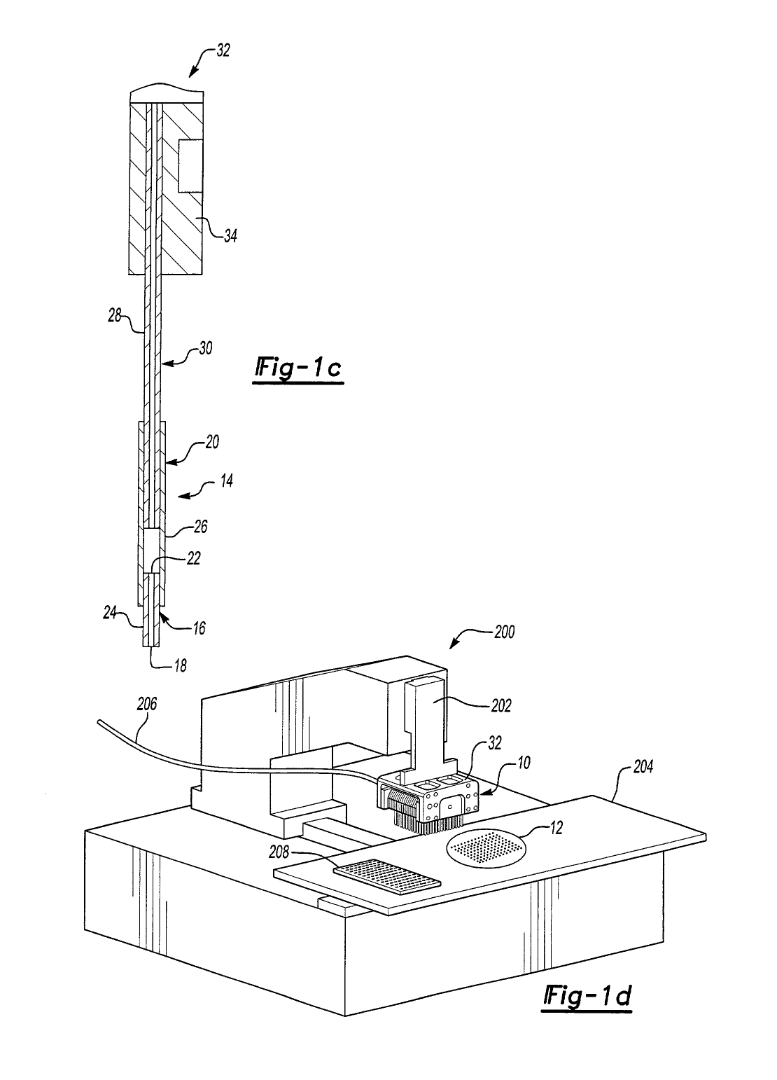

Thus, turning to FIGS. 2a and 2b, there is illustrated one type of assembly device 36 that may be employed in the assembly of one highly preferred capillary dispenser array 10 in accordance with the present invention. To form the array 10, the assembly device 16 includes a plurality of separable alignment members, each of which are adapted for holding a different piece of the array assembly, and each of which is capable of being in registered alignment with the other. By way of example, a first member 38 is configured for receiving the upstream conduits 28. In this regard, a plurality of bores may be formed in a block 40, each bore providing a holder configuration to enable the conduits 28 terminate in a common plane. As seen in FIG. 2a, one way to achieve this is to include a flat bar or plate 42 in spaced opposing relation to the block 40. In this manner, the tips 18 of each capillary can be aligned in a common plane. The block 40 of the first member 38 preferably is removable so that other blocks of different configurations, capillary size or the like may be interchanged. This is particularly advantageous as it is contemplated that the present invention may employ both disposable and reusable components. It is also preferably adjustable for applying pressure to the capillaries to keep them in place during handling, such as with a clamping fastener arrangement. A second member 44 is configured to receive the sheaths. Preferably the second member has through holes 46 adapted for receiving and holding the sheaths. The second member preferably is maintained in registered alignment with the first member. FIG. 2a illustrates one such example where a male/female mating attachment structure is employed. That is, a male projection 48 associated with one member projects into a corresponding bore associated with another member. Any suitable securing mechanism may optionally be employed for securing the first and second members to each other. For example, a set of screws or other fasteners 50 may be employed for securing engagement with the male projection 48.

The manifold 32 is adapted so that the upstream conduits 28 align generally with the sheaths held by the second member 44. Moreover, a third member 52 is adapted for holding capillaries. The manifold may be configured for securing to the second member 44 in like manner as the attachment of the first member 38 to the second member 44.

As appreciated from the above, the first member, second member, manifold or a combination of them are able to hold the capillaries parallel to each other, and spaced from each other (e.g., by no greater than about 1 mm spacing, and more preferably no greater than about 10 mm spacing (e.g., about 4 mm spacing)).

It will be appreciated also that when the first member, second member, third members and any holders 34 of the manifold 32 are assembled, the capillary 18 will penetrate at least partially into the sheath 26, as shown if FIG. 1c. The sheath being a heat shrinkable material will preferably have an inside diameter that is the same or preferably slightly larger than the outer diameter of its respective capillary. The assembly device 36, when loaded with components in place, and secured to one another for handling, can then be placed in a medium for heating the sheath above its softening point, or otherwise to a temperature at which the sheath shrinks and forms a tight seal with the capillary 24. Of course, it is also possible to use a material other than a heat shrink material for the sheath. Temperature ramp rates, maximum temperatures, times at respective temperatures or the like can be varied as desired by the skilled artisan to achieve the desired fit. Other approaches are possible as well. For instance, the capillaries and the manifold might be cooled to achieve thermal contraction so that it can be attached to the sheath. Upon warming, a tight seal is formed. Further it should be appreciated that the attachment of the holder 34 of the manifold 32 to the sheath may be performed before during or after attachment of the capillaries to the sheath. In this regard, the plate 42 is removed and the holder 34 can be placed over the conduits 28. Plural holders can be assembled and held together side by side to assemble the manifold 32.

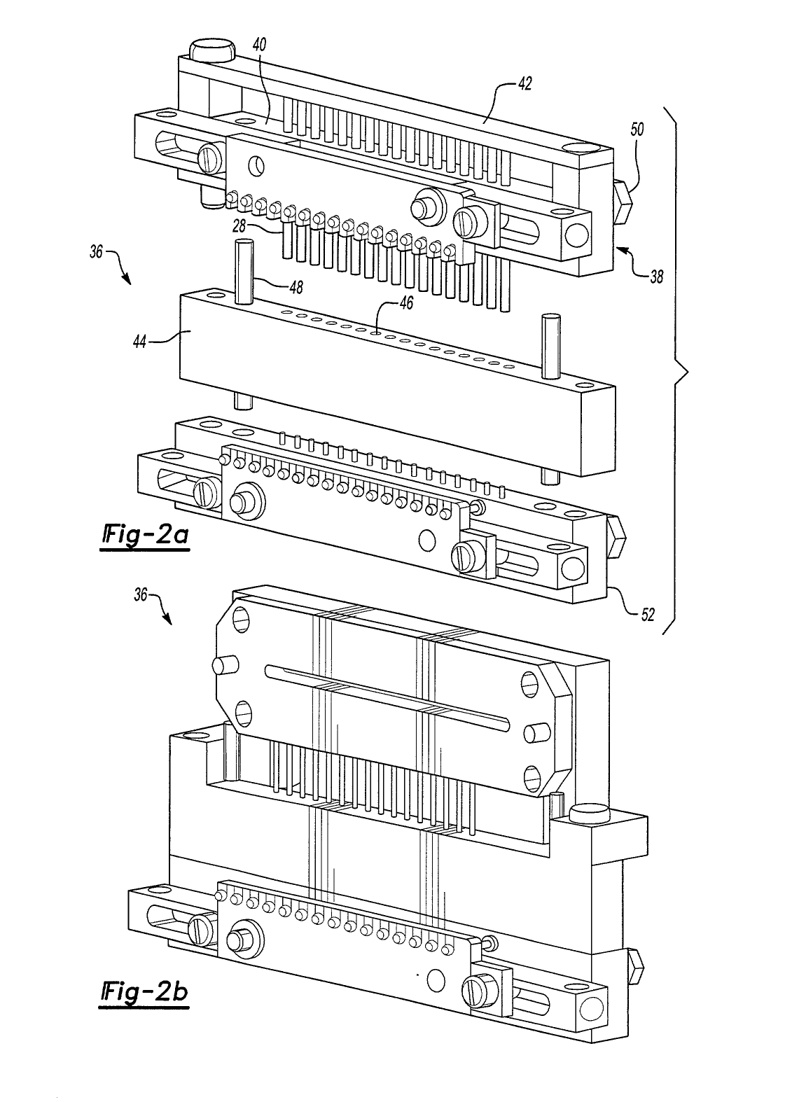

Turning to another alternative embodiment, as shown in FIGS. 3a and 3b, another type of capillary dispenser array 110 may be microfabricated on a substrate 112, such as a wafer sectioned in half. The flow paths may be generated using any suitable art-disclosed technique. Preferably, a microfluidic channel network 114 is formed on a surface 116 of the substrate 112 along its edges, such as by masking and etching a desired pattern. For example, a pattern might include a plurality of microcapillaries 118, each having a first capillary portion 120 and a second portion 122 for maintaining fluids drawn into the first portion (e.g., by capillary forces) in the first portion. The first and second portions may be different diameters. Alternatively, the first and second portion may be the same constant diameter, but are treated over their surfaces to render one portion hydrophobic and the other hydrophilic. An array of these channels may be formed in the desired pattern on the substrate. Preferably the network 114 will have a selectively formed channel structure that is in fluid communication with one or a plurality of fluid ejection pressure sources. As will be appreciated from the above, a variety of substrate materials may be employed and will be process using art-disclosed microfabrication techniques, e.g., photolithography, wet chemical etching, laser ablation, air abrasion techniques, injection molding, embossing, and other techniques. Accordingly, in some preferred aspects, the wafer material may include materials normally associated with the semiconductor industry such as silicon or glass based wafer (e.g., quartz, silica or polysilicon) as well as other wafer materials. The wafers may also include other suitable layers, such as layers of polymeric materials. As seen in FIG. 3b, it is possible to form a multidimensional dispensing array by layering a plurality of substrates 112 on top of each other and fastening, bonding or welding them to each other using art-disclosed techniques.

The pressure source for ejecting fluids in the above embodiments preferably employs a source of gas. Upon receiving a signal from a suitable controller (not shown), such as might be associated with a computer programmed for preparing a library of materials, the pressure source will release one or more pulses of gas pressure through the manifold and downstream capillaries. The pressure across each of the capillaries will be approximately equal to each other. The pressure will be sufficient to force fluids in the capillary, which have been drawn into the capillary (whether by capillary force or by suction), to be expelled from the capillary, leaving the capillary substantially free of any remaining liquid.

One system 200 of the present invention is illustrated in FIG. 1d, where it is shown that a dispensing array (shown here as an array of the type of array 10) is mounted on a robot arm 202 translatable in the x, y or z orthogonal axes. The substrate 12 is placed on a mounting stage 204, which likewise may be translatable in the x, y or z orthogonal axes. A gas supply line 206 provides gas for fluid ejection. The entire assembly may be signally controllable with a computer or other suitable controller, not shown. One or more microtiter plates 208 having liquids therein may be provided to afford fluid transfer from a microtiter plate 208 to the substrate 12. In the system shown, for instance, the robot arm 202 may raise and lower in the z-axis, while the mounting stage is translated in the x or y axes for allowing the dispensing array 10 to address both the microtitre plate 208 and the substrate 12.

Turning in more detail to the operation of the present invention, preferably fluid is introduced into dispenser array by placement of the dispenser tips into a fluid source. Using principles of fluid capillary action, the fluid enters the capillary. The fluid is permitted to travel in the capillary. Upon reaching the interface between the first portion and the second portion, the nature of the interface (e.g., the change of diameter, the change of hydrophobicities, change of material or the like) urges the fluid to remain in the first portion of the capillary.

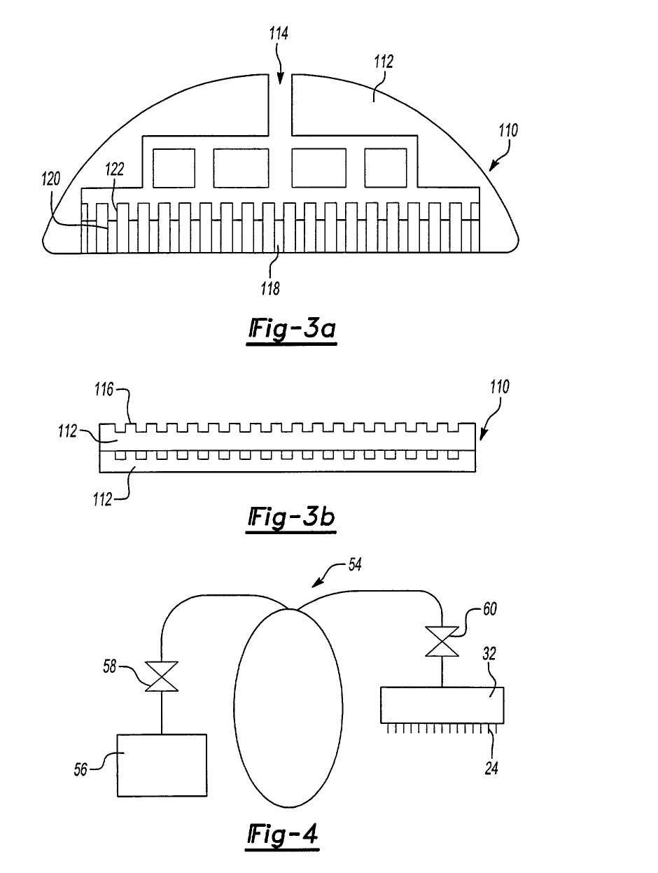

To achieve complete ejection of the fluid from the dispenser, a rapid pressure pulse is delivered to the manifold cavity from a fixed volume of gas and preferably a pressure pulse to each individual dispenser. As shown in FIG. 4, an illustrative closed system 54 is provided with a gas source 56 connected to the manifold 32. One or more valves (e.g., a first valve 58 and a second valve 60) are provided between the source and the manifold. Initially, valves are closed. The first valve 58 is opened and a fixed amount of gas is introduced into the system. Once the fixed amount of gas has entered the system, the first valve 58 is closed. The second valve 60 is then opened to emit gas into the manifold and to thereby enable a rapid pressure pulse across the manifold for fully ejecting the fluid from within each capillary simultaneously. Though it is possible to do so, by integrating a pressure pulse into the system, the dispenser, and more specifically, the capillary does not need to contact the substrate during the dispensing process, nor does it need to be mechanically agitated to cause release of droplets.

The skilled artisan will appreciate that the manifold may be varied as desired. It is possible that each dispenser has its own manifold (enabling the possibility of consecutive or simultaneous dispensing through each dispenser), no manifold at all, or that a common manifold is used for a plurality of dispensers. The shape or interior of the manifolds may be modified as desired, including through the use of controlled flow paths, fractals or baffles, to achieve a desired pressure pulse from the manifold, and preferably a pressure pulse that is substantially evenly distributed across the entire manifold. It is desirable, however, that as fluids are released from the respective dispensers that a relatively low pressure gradient is observed across the plane intersecting the axis of each of the ports or upstream conduits associated with the manifold. Further, it is desirable that the pressure pulse observed across that interior cavity is optimized to minimize the amount of gas emitted from dispensers after liquid has been ejected. For example, a relatively rapid rise and drop-off in a pressure versus time plot at about the time of fluid ejection is generally desirable although not required.

In other embodiments of the invention, the dispenser may be formed without the hydrophobic medium and successfully maintain the fluid within the capillary where the inner diameter of the interface is larger than the inner diameter of the capillary. The larger diameter forms and effective boundary and stops the fluid from creeping into the interface. The use of different diameters and/or materials having different wetting agents for the interface and the capillary also provide for maintaining the fluid within the capillary portion of the dispenser for effective ejection or dispensing onto a substrate. Moreover, other art-disclosed sources of pressure for aspiration purposes may be employed, such as piezoelectric pressure transducers or the like.

In still another embodiment, the capillary may have a tip or opening that decreases in size (e.g., is conical) toward the portion of the capillary through which fluids are to enter or exit. In such an embodiment, the amount of fluid that is drawn into the capillary may be controlled by controlling the degree of decrease in size of the opening (i.e., the change in the angle, slope or distance apart of the interior walls of the capillary) such that the capillary force that draws fluid into the capillary is balanced against the force of gravity when a desired amount of fluid has been drawn into the capillary.

It should be noted that successful operation of the present invention may require periodic cleaning, priming or both. By way of example, this may be accomplished by using one or repeated rinses with organic solvents, different cleaning solutions, such as a detergent-containing aqueous solution, mildly acidic or basic solutions, and the like. By applying gas pressure to the capillary, the cleaning solution may be expelled. The present invention also contemplates that the gas source used as the fluid ejection pressure source might be temperature controlled. Thus, warmed gas, or the like might be used to free the capillary of liquid.

It will be appreciated that the present invention thus provides an efficient approach to the transfer of fluids from a first location to a second location. Though other uses are possible, typically the first location will be a reaction or storage vessel and the second location will be a substrate on which a library is formed. Alternatively, however, transfer could be from nearly any first vessel or array of vessels to a second vessel or array of vessels. Exemplary arrays of vessels may be provided as wells of a microtiter plate, as vials in a vial rack or otherwise. Exemplary singular vessels may be provided as troughs or other containers. Additionally, an array of different solutions, an array of same solutions or a combination thereof may be transferred. Transfer may be effected from one large common solution to form an array of solutions or transfer may be effected from an array of solutions to form one common solution. Moreover, volumes or weights of solution that are substantially equivalent or substantially different may be transferred as an array or to form an array.

In a preferred embodiment, an array of compositions may be formed by transferring varying amounts of two solutions to each location of an array of locations. As an example, samples of a first solution having sizes (e.g., weights, volumes or the like) varying across a gradient may be transferred to an array of wells followed by transferring samples of a second solution also having sizes varying across a gradient such that an array of compositions having portion of both the first and second solutions is formed. Preferably, the gradient of the first solutions is opposite the gradient of the second solutions (i.e., in a well where a greater amount of the first solution is provided, a lesser amount of the second solution is provided) such that each member of the array of compositions is substantially equivalent in size.

To effectuate transfer, the dispensing array 10 or 110 might be mounted on a manually controllable fixture or more preferably on signally controllable or programmable robotic arm. Preferably the robot arm is driven by a suitable servo mechanism or stepper motor, and also preferably is translatable in the x, y, or z orthogonal axes relative to the first and second locations. It should be recognized that the robot arm may also be mounted in a fixed position, with first and second locations being on translatable stages or the like.

The present invention lends itself well to use in the rapid synthesis or treatment of one or a plurality of samples, as may be encountered in typical combinatorial chemistry or materials science research programs. For instance, the present invention can be employed for preparing libraries of materials on a substrate. The materials can then be screened for one or more useful properties thereafter, using art-disclosed screening techniques.

In general, though one aspect of the present invention contemplates rapid synthesis and characterization of individual samples in isolation, the method and system of the present invention preferably contemplates forming a library of a plurality of same or different materials using rapid-serial synthesis techniques, parallel synthesis techniques or a combination thereof. Such samples may then be screened using rapid-serial synthesis techniques, parallel synthesis techniques or a combination thereof.

In the formation of libraries in accordance with the present invention, one or a plurality of ingredients may be selected to form a desired material or may be selected to explore a compositional range or phase space potentially useful as a desired material. Ingredients are typically selected from commercially available atoms, molecules, compounds or complexes having a desired element. Ingredients typically are in a solid or liquid state, but may also be provided in a gaseous state.

Selection of the ingredients will depend largely upon the intended use of the ingredient. It is preferred that one or both of the ingredients are provided in a flowable medium (e.g., as a liquid, sol-gel, gel, etc.) for deposition onto a substrate. Typically, at least a first and a second ingredient is employed. Further, as is likely to be encountered in the synthesis and screening of potential new catalyst materials, the first ingredient and second ingredient, optionally following further processing and/or treatment, can be subjected to reactive conditions, in the presence of reactant materials. The properties of the potential catalysts, their reaction products, or both can then be analyzed.

The present invention may be employed generally for dispensing liquids for synthesizing new and yet to be characterized materials, synthesizing existing known or characterized materials, treating another material, mixing of materials, or other like uses encountered for a dispensing device.

To illustrate its versatility, the present invention might be employed for solution precipitation techniques. An example of one such preferred system is disclosed in U.S. Patent Application Entitled “A Method For Synthesizing Arrays of Materials”, Ser. No. 09/633,255 (Filed Aug. 7, 2000), hereby incorporated by reference. Thus, for example, at least two liquids are admixed optionally in the presence of a precipitating agent, and using a stirring member or the force derived from introduction of the liquids themselves. Solid precipitates form during the co-precipitation and can be separated from the liquid.

In another embodiment, the present invention may be employed for dispensing fluids for impregnating potential catalyst materials. In this manner, a catalyst support is deposited on a substrate and a liquid phase catalyst precursor is impregnated into the support. One such system useful with the present invention is disclosed in U.S. Patent Application Entitled “Method and System for the In Situ Synthesis of a Combinatorial Library of Supported Catalyst Materials”, Ser. No. 09/516,669, filed (Mar. 1, 2000), hereby incorporated by reference.

In creating libraries in accordance with the present invention, it is frequently desirable to vary the compositions or stoichiometry of the starting materials. It is also possible to vary the reaction environment conditions from region to region to create different materials or materials with different properties. By way of illustration, with particular reference to the selection of the chemistry of a first and second different ingredient, it is possible that the first ingredient is constant across the substrate, but the second ingredient is varied region to region. Likewise it is possible to vary the first ingredient across the substrate, but maintain the second ingredient constant. Moreover, it is possible to vary both the first and second ingredients across the substrate.

Examples of ratios and techniques for forming a variety of libraries are illustrated in U.S. patent application Ser. No. 09/156,857 and Ser. No. 09/156,827 entitled “Formation of Combinatorial Arrays of Materials Using Solution-Based Methodologies,” hereby incorporated by reference. Preferably a library is created having at least 4 different materials, more preferably at least 8. Amounts of different materials in excess of 10 are contemplated for a single library in accordance with the present invention. For instance, libraries may contain at least 12, 24, 36, 48, 96, 256, 500, 1000, 10⁵, or 10⁶ different materials. In some embodiments, the library can include 96×N different materials, where N ranges from 1 to about 20, and preferably from 1 to about 10 or from 1 to about 5.

By way of illustration, if there is a two-ingredient material being prepared, a phase space is formed to examine the complete range of ingredient variation. A first library may be formed by selecting an amount consistent with the size of the region being used (discussed below) and mixing an appropriate molar amount of ingredient A and ingredient B so that the first region of the substrate contains 100% of ingredient A and 0% of ingredient B. The second region may contain 90% of ingredient A and 10% of ingredient B. The third region may contain 80% of ingredient A and 20% of ingredient B. This is repeated until a final region contains 0% of ingredient A and 100% of ingredient B. Library formation in this fashion applies to as many ingredients as desired, including 3 ingredient materials, 4 ingredient materials, 5 ingredient materials, 6 or more ingredient materials, or even 10 or more ingredient materials. Like techniques may be employed in preparing libraries having stoichiometry, thickness or other chemical or physical gradients.

Moreover, in another embodiment of the present invention, a method is provided for forming at least two different libraries of materials by delivering substantially the same ingredients at substantially identical concentrations to regions on both first and second substrates and, thereafter, subjecting the ingredients on the first substrate to a first set of reaction conditions or post-delivery processing or treating conditions and the ingredients on the second substrate to a second set of reaction conditions or post-delivery processing or treating conditions. Using this method, the effects of the various reaction parameters can be studied and, in turn, optimized. Reaction, processing and/or treatment parameters which can be varied include, for example, solvents, temperatures, times, pressures, the atmospheres in which the reactions, processing or treatments are conducted, the rates at which the reactions are quenched, etc. Other reaction or treatment parameters which can be varied will be apparent to those of skill in the art. Hence, one embodiment of the invention is where a library of materials, after its formation, is thereafter subjected to further processing (such as heat treating in an alternative atmosphere) to create an library of different materials.

The library can have as many materials as there are regions on the substrate. For purposes of this invention, the number of materials is typically equal to the number of regions on the substrate, unless certain regions are left empty. The number of regions on the substrate is discussed below, but applies as well to the number of materials.

In some embodiments, a region on the porous substrate is smaller than about 25 cm², preferably less than 10 cm², more preferably less than 5 cm², even more preferably 2 cm², still more preferably less than 1 cm², and still more preferably less than 0.5 cm². In most preferred embodiments, the regions have an area less than about 10,000 μm², preferably less than 1,000 μm², more preferably less than 100 μm², and even more preferably less than 10 μm². In this manner, it is possible that relatively small sample sizes can be employed, such as on the order of about 100 micrograms to about 500 mg, more preferably about 5 to about 50 mg.

Delivery of the material to a porous substrate in accordance with the present invention can be accomplished any of a number of manual or automated methods. One preferred method and system for generating a combinatorial library and performing materials research with the library involves the employment of automated systems driven by suitable software, such as LIBRARY STUDIO™, by Symyx Technologies, Inc. (Santa Clara, Calif.); IMPRESSIONIST™, by Symyx Technologies, Inc. (Santa Clara, Calif.); or a combination thereof. The skilled artisan will appreciate that these systems can be adapted for use in the present invention, taking into account the disclosures set forth in commonly-owned copending U.S. patent application Ser. Nos. 09/174,856 and 09/305,830, each of which is hereby incorporated by reference.

Prior to delivering ingredients, mixing may be desired in preparing samples or libraries. Mixing is accomplished in any one of many manual or automatic methods. Mixing can be manual such as by shaking the vessel or well. Mixing can also be automatic such as by using an inert ball bearing in a shaken vessel or array of vessels, such as a titer plate. Mixing can also be accomplished via a dispenser that repeatedly aspirates and dispenses some or all of the contents of a vessel or well. In a preferred embodiment, mixing is performed in the nozzle of an automatic dispensing robot that repeatedly aspirates and dispenses some or all of the contents of a vessel or well. Other mixing methods include agitation of the solution with a gas stream, diffusion, sonication or other agitation techniques known to those skilled in the art.

In some embodiments, the library members are synthesized with as few as two ingredients, although the present invention may be readily adapted to form materials having 3, 4, 5, 6, or even 10 or more ingredients therein. The density of regions per unit area will be greater than 0.04 regions/cm², more preferably greater than 0.1 regions/cm², even more preferably greater than 1 region/cm², even more preferably greater than 10 regions/cm², and still more preferably greater than 100 regions/cm². In most preferred embodiments, the density of regions per unit area will be greater than 1,000 regions/cm², more preferably 10,000 regions/cm², and even more preferably greater than 100,000 regions/cm².

In a particularly preferred embodiment, without intending to be limited thereby, the present invention is used to prepare libraries of potential catalyst materials. Thus, one of the ingredients is one or more inorganic compound that is chemically inert or catalytic, preferably one containing a metal (e.g., an oxide, nitride, carbide, sulfate, phosphate) or active carbon, and still more preferably it is a ceramic. In a highly preferred embodiment, the first component is a metallic oxide, such as a known catalyst carrier. Advantageously, commercially available catalyst carriers may be employed. Such catalyst carriers are widely available, as the skilled artisan would appreciate, from vendors such as MEI Chemicals. Examples of preferred compounds include, for instance zeolites, carbon, oxides of zirconium, nickel, silicon, titanium, aluminum, cerium, yttrium, niobium, tantalum, tungsten, magnesium, calcium or mixtures thereof. Depending upon the reaction of interest, the pH can be acidic, basic or neutral. Regardless of its chemistry, the catalyst carrier should exhibit sufficient ability to adhere to regions on the substrate (whether coated, physically divided into regions or not). For instance, typically a suitable amount of a binder (e.g., up to about 5% by weight) of starch, methylcellulose, aluminum phosphate, barium sulfate of the like is added to assist in adhesion.

In such preferred embodiment, a second ingredient preferably is a metal or metal alloy and is provided as one or more catalyst precursor. For an embodiment in which a catalyst is desired to be prepared, and the first component is a metal oxide, preferably the second component is provided as an aqueous or organic metal solution, preferably one in which the fluid can be readily driven off (e.g., to yield a salt). Examples of such preferred precursors include, without limitation, solutions of oxides, alkoxides, aryloxides, allyloxides, diketonates, oxalkoxides, oxoaryloxides, oxodiketonates, phosphates (e.g., those of Al, Zr or V), phosphines, acetates, oxalates, tartrates, citrates, carbonates, halides, sulfates, nitrites, nitrates, hydroxides, amines, amides, imides, carbonyls, metals, carboxylates, or mixtures thereof. In some embodiments, the second ingredient may be the same as the first ingredient.

The libraries in accordance with the present invention lend themselves to the testing of diverse properties. Thus, the libraries can be screened by x-ray crystallography, infrared techniques, chromatographic techniques, resonance, spectroscopy, light scatter, spectrometry, microscopy, optical measurements, electrochemical measurements. By way of example, X-ray diffraction (XRD) and X-ray fluorescence (XRF) can be used in combination to determine the material crystal structure and composition, respectively. Other suitable screens might be gleaned from commonly owned U.S. Pat. Nos. 5,776,359; 5,959,297; 6,013,199; 6,034,775; 6,087,181; 6,151,123; 6,157,449; 6,175,409; 6,182,499; and 6,187,164 (all of which are hereby incorporated by reference), as well as other commonly owned patent properties. Thus, it can be seen how those of skill in this art can effectively utilize the methods of this invention for a combinatorial materials science research program.

Another aspect of the present invention involves correlating the data received from the screen of the materials synthesized according to the present invention with information known about ingredients of each of the materials, processing conditions of each of the materials or a combination thereof. The respective samples of one or more libraries can be compared with each other based upon the data and ranked. In this manner, a large field of research candidates can be narrowed to a smaller field by identifying the candidates that perform better than others with respect to a predetermined property or structure. Comparative review of results might lead to rankings of performance from better to worse, or the like. Likewise, a large field of research candidates can be narrowed to a smaller one by identifying those that meet a certain predetermined criteria (e.g., whether a crystal structure is formed). Further libraries can be prepared for further analysis. Alternatively, bulk quantities of materials having the desired properties or structures can be made for commercial applications. Data analysis may be performed manually, or by semi-automated or automated techniques. For example, it is possible to employ either or both of the LIBRARY STUDIO™ and IMPRESSIONIST™ software to assist in correlating the data.

The present invention thus allows many materials (e.g., greater than 4) to be prepared and tested rapidly. In this manner, the achievement of large amounts of data is possible over a short period of time. For example sample preparation throughputs from initial preparation through deposition onto the porous substrate are possible of no longer than 10 minutes per sample, more preferably no longer than 3 minutes per sample, and still more preferably no longer than 1 minute per sample. Further, libraries on a single substrate of at least 8 members can be deposited onto a substrate at a rate of no longer than 40 minutes per library, and more preferably less than 10 minutes per library, and still more preferably no longer than about 1 minute per library. Moreover, because the amounts needed for screening are relatively small, (e.g., less than 1 gram, and preferably less than 1 milligram), time and expense savings on sample preparation are also realizable.

From the above, it will be readily appreciated how the present invention advantageously is employed in the rapid preparation of one or a plurality of newly synthesized but uncharacterized materials. The invention may also be employed for the rapid preparation of existing known materials.

The following Examples illustrate the use of the present invention.

### EXAMPLE 1

A library of 256 (16×16) catalysts is prepared on a glass wafer by incipient wetness impegnation. The glass wafer is first silanized and 256 wells are etched onto the surface of the wafer. Each well is loaded with like amounts of the same composition catalyst carrier, by dispensing a slurry into each well and drying the slurry, to result in a porous structure. Different metal catalyst precursors are prepared (e.g., using suitable automated dispensing) in liquids in each of the spaced wells of one or a plurality of microtitre plates. The spacing of the center points of the microtitre wells correspond with the spacing of the center points of the wells on the wafer (e.g., 4 mm).

A 256 (16×16) dispenser dispensing array is primed to refresh its interior surfaces (e.g., with multiple washes in suitable liquid, such as a solvent, potassium hydroxide solution, or the like). Tips of dispensers of the 256 dispenser dispensing array of the present invention are placed in contact with the precursor liquids in the microtiter plate and the precursor fluids are drawn by capillary action into the dispensers. The dispensing array is removed from contact with microtitre plate fluids while still holding the withdrawn fluids in the dispensers. Each dispenser of the dispensing array is then brought into alignment with a corresponding catalyst carrier on the wafer. Contact between the array and the catalyst carrier is avoided. Thus, as with other types of libraries that may be prepared with the present invention, the distance of the capillary tip portion from the catalyst carrier may be varied, generally being at least about 0.1 mm to about 5 mm apart, and more preferably not more than about 0.3 mm apart.

Thereafter, a force is applied simultaneously to expel each of the fluids in the dispenser through its tip and into contact with the catalyst carrier. This step is repeated as desired to achieve desired loading and then the impregnated library is dried, calcined and tested for catalytic activity.

Randomly selected dispensers from the above dispensing array are examined for efficacy and repeatability. With a target dispensing amount of about 200 nL, the dispensers exhibit a range from about 185 to about 220 nL actual dispensed, with a standard deviation of about 2 to about 6%. The average amount dispensed per dispenser over the entire array is about 190 to about 202 nL, demonstrating successfully the ability of the present invention to reproducibly dispense nanoliter quantities of materials in their desired amounts, and within acceptable levels of deviation.

### EXAMPLE 2

The procedure of Example 1 is employed, but the wells on the wafer do not employ the same composition catalyst carrier in each well. Like processing results are obtained.

### EXAMPLE 3

The procedure of Example 1 is employed, but the wells on the wafer do not employ the same composition catalyst carrier in each well and do not include the same catalyst precursor composition in each well of the microtitre plate. Like processing results are obtained.

### EXAMPLE 4

The procedure of Example 1 is employed, but the wells on the microtitre plate employ the same precursor composition in each well. Like processing results are obtained.

### EXAMPLES 5-8

The procedures respectively of Examples 1-4 are employed but a variable processing condition such as calcine treatment or amount dispensed is employed across the wafer for the impregnated catalysts.

Although the invention has been described with particular reference to certain preferred embodiments thereof, variations and modifications can be effected within the spirit and scope of the following claims.

What is claimed is:

1. An apparatus for non-contact dispensing of a fluid onto a substrate comprising:
a hydrophilic interior wall of a conduit dimensioned for drawing a liquid by capillary action therein in a volume less than about 10 microliters;
a hydrophobic medium adjoining said hydrophilic wall and defining an interface therewith for resisting flow of said liquid into said capillary beyond said interface; and
a source of a pressure for ejecting fluids drawn into said capillary.

2. An apparatus as in claim 1, wherein said source is adapted for delivering a pressure pulse for ejecting fluids.

3. An apparatus as in claim 2, wherein said pressure pulse displays a relatively rapid rise and drop-off in pressure at about the time of fluid ejection.

4. An apparatus as in claim 1, wherein said volume is less than about 5 microliters.

5. An apparatus as in claim 1, wherein said volume is less than about 2 microliters.

6. An apparatus as in claim 1, wherein said hydrophobic medium is at least partially formed as a coating.

7. An apparatus as in claim 1, wherein said hydrophobic medium is at least partially formed of a polymeric material.

8. A method for non-contact dispensing of a fluid onto a substrate comprising the steps of:
a) providing an apparatus for non-contact dispensing of a fluid onto a substrate including:
a hydrophilic capillary dimensioned for drawing a liquid therein in a volume less than about 10 microliters;
a hydrophobic medium sealingly adjoining said capillary and defining an interface therewith for resisting flow of said liquid into said capillary beyond said interface; and
a source of a pressure for ejecting fluids drawn into said capillary;
b) drawing a liquid from a liquid source into said capillary substantially entirely by capillary action;
c) stopping the flow of said liquid substantially at said interface;
d) aligning said capillary with a predetermined location on said substrate; and
e) applying a pressure for ejecting fluids drawn into said capillary onto said substrate.

9. A method as in claim 8, wherein said source is adapted for delivering a pressure pulse and said step of applying a pressure includes applying a pressure pulse for ejecting fluids.

10. A method as in claim 8, wherein said volume is less than about 5 microliters.

11. A method as in claim 8, wherein said volume is less than about 2 microliters.

12. A method as in claim 8, wherein said hydrophobic medium is at least partially formed of a polymeric material.

13. A method as in claim 8, wherein said apparatus further includes another capillary and each of the capillaries includes a tip for assisting in dispensing fluids and the tips of each of the capillaries are aligned in a common plane.

14. A method as in claim 13, wherein each of the capillaries is capable of delivering a different volume of fluid.

15. A method for non-contact parallel dispensing of fluids onto a substrate for forming a library of materials comprising the steps of:
a) providing an apparatus for non-contact dispensing of a fluid onto a substrate including:
a plurality of parallel hydrophilic capillaries, each dimensioned for drawing a liquid therein in a volume less than about 10 microliters;
a hydrophobic medium sealingly adjoining each of said capillaries and defining an interface therewith for resisting flow of said liquid into each said capillary beyond said interface; and
a source of a pressure pulse for ejecting fluids drawn into said capillaries;
b) drawing a liquid from a liquid source into said capillaries substantially entirely by capillary action;
c) stopping the flow of said liquid substantially at said interface;
d) aligning said capillaries with a predetermined location on said substrate; and
e) applying a pressure pulse for ejecting fluids drawn into said capillaries simultaneously onto regions of said substrate for defining a library of materials.

16. A method as in claim 15, wherein said volume is less than about 5 microliters.

17. A method as in claim 15, wherein said volume is less than about 2 microliters.

18. A method as in claim 15, wherein said hydrophobic medium is at least partially formed of a polymeric material.

19. A method as in claim 15, wherein at least one of the plurality of capillaries is capable of delivering a different amount of fluid than at least one other of the plurality of capillaries.

20. A method as in claim 15, wherein each of the plurality of capillaries includes a tip for assisting in dispensing fluids and the tips of each of the plurality of capillaries are aligned in a common plane.

21. A method as in claim 15, wherein at least one of the plurality of capillaries includes a tip that is dimensionally different from at least one other of the plurality of capillaries for delivering a different amount of fluid than the at least one other of the plurality of capillaries.
